(19) United States
(12) Patent Application Publication
(10) Pub. No.: US 2009/0059216 A1
(43) Pub. Date: Mar. 5, 2009

(54) DEFECT INSPECTION METHOD AND DEFECT INSPECTION APPARATUS

(76) Inventors: Yukihiro Shibata, Fujisawa (JP); Shunji Maeda, Yokohama (JP); Shuichi Chikamatsu, Konosu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/136,799

(22) Filed: Jun. 11, 2008

(30) Foreign Application Priority Data
Aug. 29, 2007 (JP) 2007-222105

(51) Int. Cl. G01N 21/88

(52) U.S. Cl. 356/237.4

(57) ABSTRACT

A defect inspection apparatus comprises: a stage which scans a sample in a horizontal plane; an illumination optical system which illuminates light at an oblique angle with respect to a normal of a sample surface, and illuminates light in a linear form on the sample at an angle inclined to a direction perpendicular to the scanning direction of the stage; a front scattered light detection optical system which is disposed in the same orientation as the scanning direction, positioned at an elevation angle where a specular reflection light from a pattern parallel to the scanning direction is not spatially detected, and detects scattered light from a region illuminated in the linear form; an image sensor detecting an image formed by the front scattered light detection optical system; and an image processing unit performing a comparison operation of the image detected by the image sensor, thereby determining a defect candidate.

### CROSS-REFERENCE TO RELATED APPLICATION

The present application claims priority from Japanese Patent Application No. JP 2007-222105 filed on Aug. 29, 2007, the content of which is hereby incorporated by reference into this application.

### TECHNICAL FIELD OF THE INVENTION

The present invention relates to a defect inspection method and a defect inspection apparatus for defects and foreign matters of the fine patterns which are formed on a substrate through the thin-film process as typified by the semiconductor manufacturing process and the manufacturing process of a flat panel display.

### BACKGROUND OF THE INVENTION

As a conventional semiconductor inspection apparatus, International Publication Pamphlet No. 99/06823 (Patent Document 1) describes an inspection apparatus. In this inspection apparatus, laser light is illuminated in a linear form at an oblique angle with respect to a normal of a wafer. The longitudinal direction of this linear form coincides with the incidence plane of the illumination light, and the light scattered from the illumination region on the wafer is captured by a detection optical system and a scattered image is detected by an image sensor. At this time, the central portion of the image sensor is present in a flat plane substantially vertical to the incidence plane of the beam illuminated in a linear form. Therefore, a side-scattered light is the scattered light detected by the image sensor. These detected images are subjected to the comparison operation with an image of an adjacent die on which the same pattern is formed in design, so that the defects are detected.

### SUMMARY OF THE INVENTION

Various patterns are formed on a wafer to be inspected, and various types of defects exist depending on the causes thereof. The distribution of the scattered light from the defect changes depending on a size of the defect, a material, directionality, a surface state, a wavelength of the illumination light, polarization, orientation, and an elevation angle.

Accordingly, in the side-scattered light detection shown in the background technology, in the case of a defect size and defect species having a strong intensity distribution for the front scattering, the amount of light for capturing the scattered light is insufficient, and there is high possibility that the defects are overlooked. Therefore, it is important that the direction of the scattered light to be detected can be selected in consideration of the various scattered light distributions according to the defects.

Also, a specular reflection light from a normal pattern is the element which is not required to be detected in the defect inspection. However, since the specular reflection light from the normal pattern changes depending on the relative directionality of the pattern and the illumination light, the specular reflection light is captured by the detection system in some cases. When the scattered light from a normal pattern is captured, since the scattered light from the defect which is finer than a pattern is smaller than the scattered light of a normal pattern, there occurs the problem that the scattered light of the defect is buried in the scattered light of a normal pattern and cannot be detected as a defect.

Thus, an object of the present invention is to provide a defect inspection method and a defect inspection apparatus with a high detection sensitivity.

The novel characteristics of the present invention will be apparent from the description of this specification and the accompanying drawings.

The typical ones of the inventions disclosed in this application will be briefly described as follows.

A defect inspection method according to the present invention is a defect inspection method for detecting a defect of a sample on which circuit patterns are formed, wherein the sample is scanned in a horizontal plane by a scanning unit, light is illuminated to the sample at an oblique angle with respect to a normal of a surface of the sample by an illumination optical unit, the illumination light is illuminated in a linear form on the sample at an angle inclined with respect to a direction perpendicular to the scanning direction, scattered light from the region illuminated in the linear form is detected by a detection optical unit, the detection optical unit is disposed in the same orientation as the scanning direction and has an aperture which does not spatially detect a specular reflection light from a pattern parallel to the scanning direction, an image formed by the detection optical unit is detected by an image sensor, and the image detected by the image sensor is subjected to a comparison operation by an image processing unit, thereby determining a defect candidate.

Further, a defect inspection method according to the present invention is a defect inspection method for detecting a defect of a sample on which circuit patterns are formed, wherein the sample is scanned in a horizontal plane by a scanning unit, light is illuminated to the sample in a linear form at an oblique angle with respect to a normal of a surface of the sample by an illumination optical unit, scattered light from a region illuminated in the linear form is detected by a detection optical unit with NA of 0.7 or more, the scattered light detected by the detection optical unit is branched into at least two or more optical paths by polarization separation, at least one of the optical paths branched into two optical paths is further branched into two or more optical paths by a Fourier transform plane, images formed by each of the optical paths are detected by a plurality of image sensors disposed on each of the optical paths, and the images detected by the plurality of image sensors are subjected to a comparison operation by an image processing unit, thereby determining a defect candidate.

Further, a defect inspection apparatus according to the present invention is a defect inspection apparatus for detecting a defect of a sample on which circuit patterns are formed, and the apparatus comprises: a scanning unit which scans the sample in a horizontal plane; an illumination optical unit which illuminates light to the sample at an oblique angle with respect to a normal of a surface of the sample, and illuminates light in a linear form on the sample at an angle inclined with respect to a direction perpendicular to the scanning direction of the scanning unit; a detection optical unit which is disposed in the same orientation as the scanning direction, positioned at an elevation angle where a specular reflection light from a pattern parallel to the scanning direction is not spatially detected, and detects scattered light from a region illuminated in the linear form; an image sensor which detects an image formed by the detection optical unit; and an image processing unit which performs a comparison operation of the image detected by the image sensor, thereby determining a defect candidate.

Further, a defect inspection apparatus according to the present invention is a defect inspection apparatus for detecting a defect of a sample on which circuit patterns are formed, and the apparatus comprises: a scanning unit which scans the sample in a horizontal plane; an illumination optical unit which illuminates light to the sample at an oblique angle with respect to a normal of a surface of the sample, and illuminates light in a linear form on the sample at an angle inclined with respect to a direction perpendicular to the scanning direction of the scanning unit; a detection optical unit with NA of 0.7 or more which detects scattered light from a region illuminated in the linear form; first branching means which branches the scattered light detected by the detection optical unit into at least two or more optical paths by polarization separation; second branching means which further branches at least one of the optical paths branched by the first branching means into two or more optical paths by a Fourier transform plane; a plurality of image sensors which detect images formed by each of the optical paths branched by the first branching means and the second branching means; and an image processing unit which performs a comparison operation of the images detected by the plurality of image sensors, thereby determining a defect candidate.

These and other objects, features and advantages of the invention will be apparent from the following more particular description of preferred embodiments of the invention, as illustrated in the accompanying drawings.

### BRIEF DESCRIPTIONS OF THE DRAWINGS

FIG. 1 is a configuration diagram showing a configuration of a defect inspection apparatus according to the first embodiment of the present invention;

FIG. 2 is an explanatory diagram for describing an orientation of an oblique illumination light of the defect inspection apparatus according to the first embodiment of the present invention;

FIG. 3A is an explanatory diagram for describing the correlation of the orientation of the illumination light and the orientation for detecting the scattered light in the detection optical system in the defect inspection apparatus according to the first embodiment of the present invention;

FIG. 3B is an explanatory diagram for describing the correlation of the orientation of the illumination light and the orientation for detecting the scattered light in the detection optical system in the defect inspection apparatus according to the first embodiment of the present invention;

FIG. 4 is an explanatory diagram for describing the illumination orientation of the illumination optical system in the defect inspection apparatus according to the first embodiment of the present invention;

FIG. 5 is a configuration diagram showing the configuration of the illumination optical system in the defect inspection apparatus according to the first embodiment of the present invention;

FIG. 6 is an explanatory diagram for describing a positional relation of the illumination light and the scattered light detection optical system in the defect inspection apparatus according to the first embodiment of the present invention;

FIG. 7 is an explanatory diagram for describing a scattered light detection optical system in a defect inspection apparatus according to the second embodiment of the present invention;

FIG. 8 is a configuration diagram showing the configuration of the scattered light detection optical system in the defect inspection apparatus according to the second embodiment of the present invention;

FIG. 9 is a block diagram for describing a defect determination process in an image processing unit in the defect inspection apparatus according to the second embodiment of the present invention;

FIG. 10 is a block diagram for describing a defect determination process in an image processing unit in the defect inspection apparatus according to the second embodiment of the present invention; and

FIG. 11 is a configuration diagram showing a configuration of a scattered light detection optical system in a defect inspection apparatus according to the third embodiment of the present invention.

### DESCRIPTIONS OF THE PREFERRED EMBODIMENTS

Hereinafter, embodiments of the present invention will be described in detail with reference to the accompanying drawings. Note that components having the same function are denoted by the same reference numbers throughout the drawings for describing the embodiment, and the repetitive description thereof will be omitted.

### First Embodiment

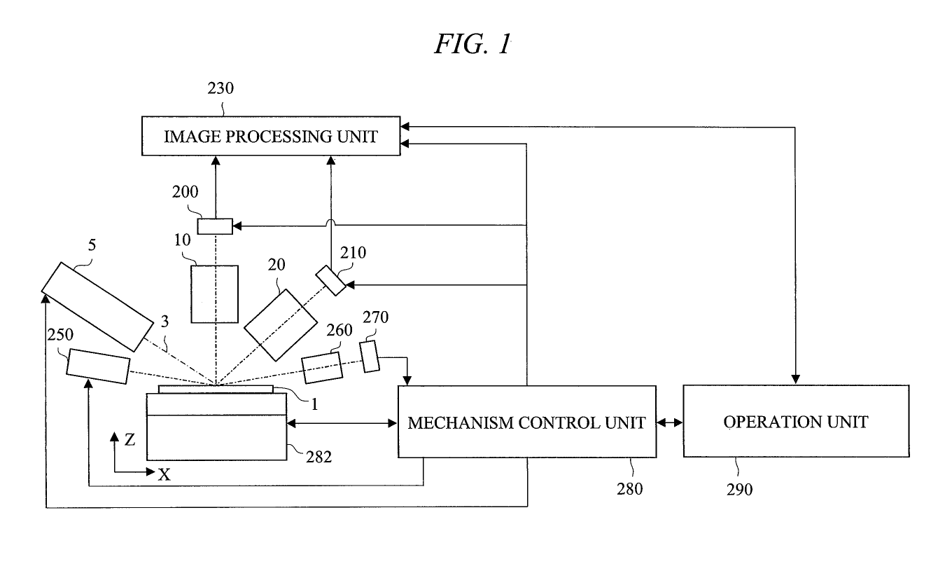

The configuration of a defect inspection apparatus according to the first embodiment of the present invention will be described with reference to FIG. 1. FIG. 1 is a configuration diagram showing a configuration of a defect inspection apparatus according to the first embodiment of the present invention.

In FIG. 1, the defect inspection apparatus includes an illumination optical system 5, an upward scattered light detection optical system 10, a front scattered light detection optical system 20, image sensors 200 and 210, an image processing unit 230, an AF (Auto Focus) illumination system 250, an AF detection system 260, a photodetector 270, a mechanism control unit 280, and an operation unit 290.

Further, a wafer 1 to be inspected is placed on a stage 282, and the wafer is illuminated at an oblique angle along an optical axis 3 of the illumination light by the illumination optical system 5 obliquely disposed for the wafer 1. The light scattered by a defect and a pattern of a wafer is captured by the upward scattered light detection optical system 10.

The front scattered light detection optical system 20 is disposed to detect scattered light with the orientation different from that of the upward scattered light detection optical system 10. The optical axes of the upward scattered light detection optical system 10 and the front scattered light detection optical system 20 are present in an XZ plane formed by a direction X in which the wafer 1 is scanned and a normal Z of a wafer surface.

The image sensors 200 and 210 are disposed at imaging planes of the scattered light detection optical systems (though an example of two scattered light detection optical systems is shown in FIG. 1, a system in which three or more scattered light detection optical systems are disposed is conceivable easily, and in this case, all the optical axes of the scattered light detection optical systems are present in the XZ plane).

The images detected by the image sensors 200 and 210 are sent to the image processing unit 230. In this image processing unit 230, the adjacent images are aligned, and a defect is detected by a comparison operation of the images.

Defect information including coordinates and a size of the defect and an image feature amount of the defect is sent to the operation unit 290. At the operation unit 290, a person operates the inspection apparatus, by which the creation of an inspection recipe, the order for the inspection by the created recipe, the map display of inspection result and the feature amount display of a detected defect are performed through GUI (Graphical User Interface).

For example, when the inspection is ordered from the operation unit 290, a command is issued from the mechanism control unit 280 to the stage 282 as a scanning unit to move to a staring point of the inspection. The distance of the stage 282 is sent to the mechanism control unit 280 from the stage 282, it is determined whether the stage 282 is positioned within an allowable range for the ordered distance, and when the stage 282 is out of the allowable range, the feedback control is performed so that it is positioned in the allowable range.

Next, when the image sensors 200 and 210 are one-dimensional image sensors (including TDI (Time Delay Integration) type), the image of the surface of the wafer 1 is obtained while moving the stage 282 in an X direction at a uniform speed. In the case of the TDI image sensor, when the speed of the stage 282 becomes nonuniform, the detected image becomes blurred. Therefore, speed information of the stage 282 is sent to the mechanism control unit 280, and it is synchronized with the timing of the vertical transfer of the image sensors 200 and 210.

Further, due to the warpage of the surface of the wafer 1 and the deviation in the X direction in moving the stage, the position of the surface of the wafer 1 is misaligned with the focal point of the optical system in some cases. Therefore, for example, a slit image is projected onto the surface of the wafer from the AF (Auto Focus) illumination system 250, and the reflected slit image is formed by the AF inspection system 260 and detected by the photodetector 270. Information of the detected slit image is sent to the mechanism control unit, and height information of the wafer 1 is calculated.

The height of the wafer 1 can be detected by calculating the position of the detected slit image. This method is an AF method generally referred to as an optical lever method. Other than this AF method, an optical lever method by TTL (Through The Lens) or a stripe pattern projection method is also known.

When a difference between the height information of the wafer 1 detected by the AF method and the focal point of the upward scattered light detection optical system 10 is equal to or larger than the allowable range, an order to drive the Z-axis actuator of the stage 282 is issued from the mechanism control unit 280 so that the difference is kept within the allowable range, thereby preventing the defocus of the images detected by the image sensors 200 and 210.

The image sensors 200 and 210 detect an image of the same position on the wafer 1. For example, in the case where the wafer 1 is a mixed-mounting wafer (system LSI or the like) on which a memory and a logic circuit are formed, the light from a memory unit is blocked by a spatial filter disposed in the upward scattered light detection optical system 10. Therefore, as for the detected image, only the scattered light from a random defect is detected.

On the other hand, since the light from an irregular logic pattern cannot be blocked by a spatial filter such as a memory unit, the amount of light reaching the image sensor is large. The difference of the detected light amount is corrected, and both the memory unit and the logic unit detect images of the respective regions with the appropriate dynamic ranges of the image sensors 200 and 210. As the means for this, the region is divided while paying attention to the periodicity of a pattern, and images are detected for each of the divided regions by the image sensors 200 and 210.

Note that, although the example in which the periodicity is divided into two regions will be describe here, it is apparent that the method in which the number of divided regions is increased to 3, 4 or 5 and the respective images are detected by the corresponding number of image sensors is also within the scope of the present embodiment.

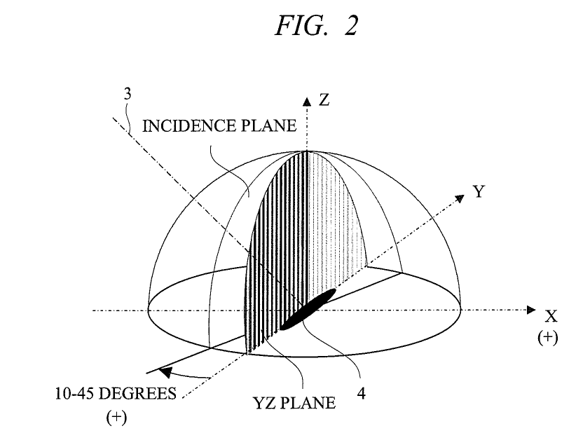

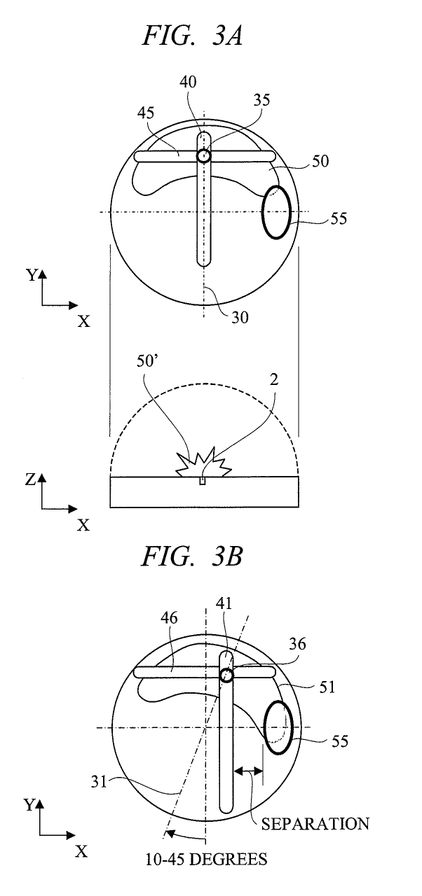

Next, an orientation of the oblique illumination light of the defect inspection apparatus according to the first embodiment of the present invention will be described with reference to FIG. 2 and FIG. 3. FIG. 2 is an explanatory diagram for describing an orientation of an oblique illumination light of the defect inspection apparatus according to the first embodiment of the present invention, and FIG. 3 is an explanatory diagram for describing the correlation of the orientation of the illumination light and the orientation for detecting the scattered light in the detection optical system in the defect inspection apparatus according to the first embodiment of the present invention.

In FIG. 2, the direction in which the wafer 1 is continuously scanned to obtain an image is defined as X, the direction perpendicular to X in the wafer plane is defined as Y, and the direction perpendicular to an XY plane (wafer in-plane) is defined as Z.

The incidence plane defined by the optical axis 3 of the illumination light and a normal of the wafer surface at the illumination position on the wafer forms an angle of 10 degrees or more with respect to the YZ plane perpendicular to the stage scanning direction X. On the other hand, the longitudinal direction of linear illumination 4 which illuminates the wafer 1 is approximately parallel to the Y direction. Accordingly, by disposing the scattered light detection optical system to capture the scattered light at an angle inclined in the X direction with respect to the Z axis, the front scattered light can be captured.

FIG. 3 shows the correlation of the orientation of the optical axis 3 of the illumination light and the orientation to detect the scattered light in the detection optical system.

FIG. 3A shows an XZ plan view of the wafer 1 seen from the section and an XY plan view of the wafer 1 seen from above.

When the defect 2 is present on the wafer surface of the XZ plan view and the defect portion is illuminated, a hemispherical distribution 50′ of the scattered light is generated. The distribution obtained by projecting the hemisphere onto an XY plane is shown in the XY plan view. The illumination light is located at the position 30, and the light specularly reflected by the flat portion of the wafer 1 is located at the position 35 with the apex of the hemisphere as a symmetric axis. It is assumed that normal patterns are irregularly arranged on the wafer 1 in the X and Y directions. In this case, the specular reflection light from an X pattern is mainly collected onto the line 40 in the Y direction including the specular reflection light 35 of a flat portion. Also, the specular reflection light from a Y pattern is mainly collected onto the line 45 in the X direction including the specular reflection light 35 of a flat portion.

On the other hand, the defect scattered light distribution 50 with a shape different from the patterns shows the distribution different from the scattered light distributions 40 and 45 of the patterns.

Note that the defect scattered light distribution 50 is an example in which the front scattered light intensity is strong. Also, a dark field image is formed by the scattered light overlapped with (captured by) an aperture 55 of the scattered light detection optical system. In the example of FIG. 3A, the region where the aperture 55 of the dark field detection optical system and the defect scattered light distribution 50 is overlapped is narrow.

Meanwhile, FIG. 3B shows an example having the illumination orientation shown in FIG. 2. By inclining the illumination orientation at about 10 degrees with respect to the Y axis, the defect scattered light distribution 51 rotates correspondingly.

By this means, the region in which the aperture 55 of the scattered light detection optical system and the defect scattered light distribution 51 are overlapped is widened, and the scattered light from the defect which can be captured is increased. Meanwhile, with regard to the scattered light from the pattern, since the illumination orientation is inclined at about 10 degrees, the distributions of the pattern scattered lights 41 and 46 also shift, but the distributions 41 and 46 are not overlapped with the aperture 55 of the scattered light detection optical system in this configuration.

In this manner, the scattered light of the defect captured by the scattered light detection optical system can be increased, and the scattered light from a normal pattern can be suppressed. Therefore, an inspection S/N ratio can be improved.

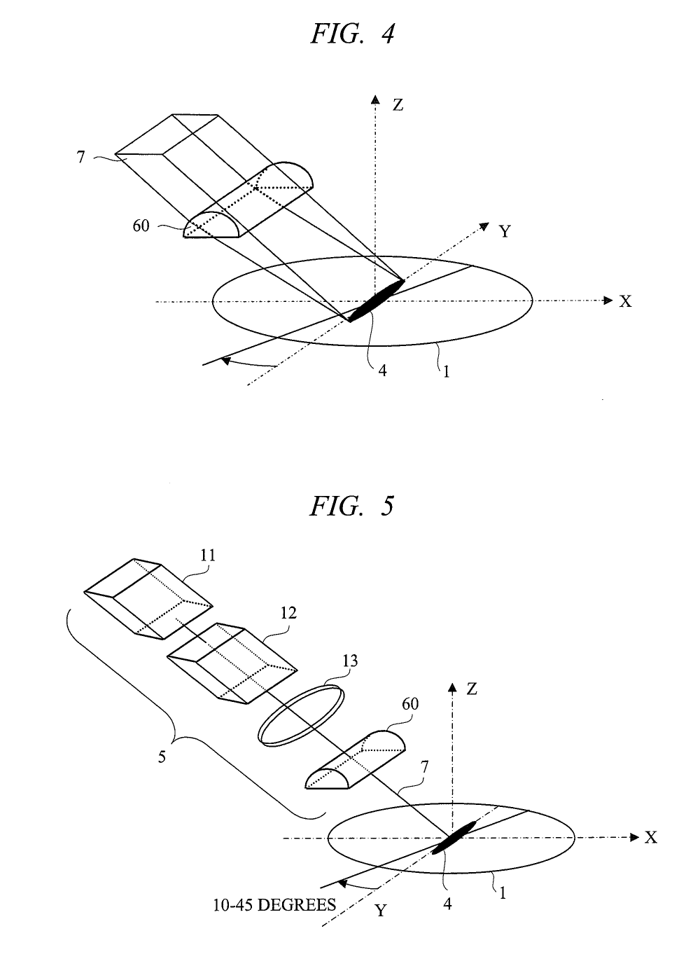

Next, the configuration of the illumination optical system of the defect inspection apparatus according to the first embodiment of the present invention will be described with reference to FIG. 4 and FIG. 5. FIG. 4 is an explanatory diagram for describing the illumination orientation of the illumination optical system in the defect inspection apparatus according to the first embodiment of the present invention, and FIG. 5 is a configuration diagram showing the configuration of the illumination optical system in the defect inspection apparatus according to the first embodiment of the present invention.

In FIG. 4, the light emitted from a light source is shaped into a desired shape 7, and it is incident on a cylindrical lens 60 disposed near the wafer 1. The cylindrical lens 60 is disposed almost in parallel to the longitudinal direction Y of the linear illumination 4, and a flat surface portion (rear surface of the curved surface) of the lens is almost parallel to the XY plane. Further, the incident orientation of the illumination light is set so that the incidence plane of the illumination light for the wafer forms an angle of about 10 degrees with respect to the YZ plane.

In FIG. 5, as the light source 11 of the illumination optical system 5, a laser and a ramp (mercury lamp, mercury-xenon lamp, xenon lamp or the like) can be adopted. Since the amount of scattered light is increased by shortening the illumination wavelength, a UV (Ultraviolet) light and a DUV (Deep Ultraviolet) light can also be adopted. The 355-nm laser, 266-nm laser, 248-nm laser, 199-nm laser, and 193-nm laser can be applied as the candidates of the laser light, and when the multi-wavelength illumination by laser light sources is to be performed, it is necessary to dispose a plurality of laser light sources.

An example in which a laser (hereinafter, referred to as laser 11) is used for the light source 11 is described in this embodiment.

The light emitted by the laser 11 changes its beam shape (size, ellipticity) into an arbitrary shape by the beam shaping lens system 12. Although the laser beam is linearly polarized, a rotatable half-wave plate 13 is disposed so that S polarization and P polarization can be selected for wafer 1. In addition, when it is necessary to select an elliptic polarization, a rotatable quarter-wave plate similar to the half-wave plate 13 has to be disposed (quarter-wave plate is not illustrated). The light that has penetrated through the half-wave plate 13 is incident onto the cylindrical lens 60 and is illuminated in a linear form in parallel to the Y direction on the wafer 1.

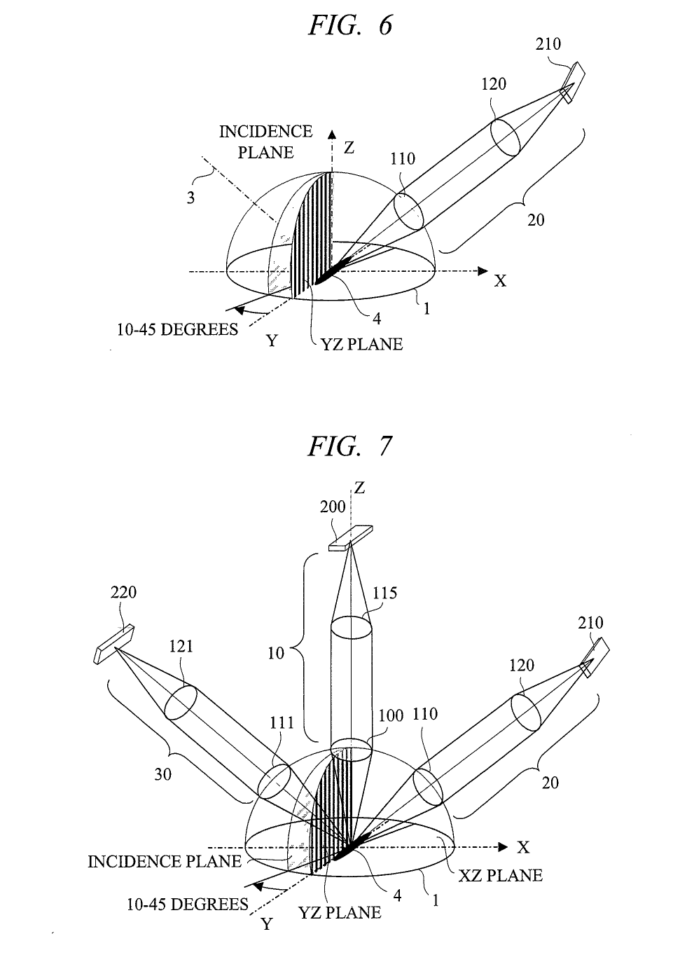

Next, the positional relation of the illumination light and the scattered light detection optical system in the defect inspection apparatus according to the first embodiment of the present invention will be described with reference to FIG. 6. FIG. 6 is an explanatory diagram for describing a positional relation of the illumination light and the scattered light detection optical system in the defect inspection apparatus according to the first embodiment of the present invention.

The angle formed by the Y direction perpendicular to the stage scanning direction X with respect to the incidence plane of the light axis 3 of the illumination light is preferably 10 degrees to 45 degrees. The longitudinal direction illuminating the wafer 1 in a linear form with the optical axis 3 of the illumination light is approximately the Y direction, and the scattered light detection direction of the front scattered light detection optical system 20 is the X direction. Accordingly, the scattered light captured by the scattered light detection optical system 20 with respect to the optical axis 3 of the illumination light is the front scattered light, and the light scattered in this direction can be detected.

### Second Embodiment

In the second embodiment, since scattering distributions differ depending on a defect species, the front scattered light, the wafer upward scattered light (mainly, side scattered light), and the back scattered light are detected independently in order to improve the capture rate of various types of defects.

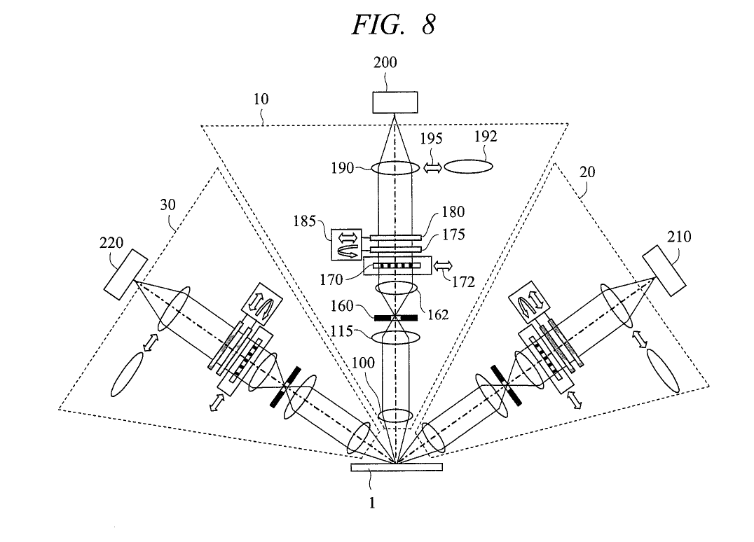

The configuration of the defect inspection apparatus according to the second embodiment of the present invention will be described with reference to FIG. 7 and FIG. 8. FIG. 7 is an explanatory diagram for describing a scattered light detection optical system in the defect inspection apparatus according to the second embodiment of the present invention, and FIG. 8 is a configuration diagram showing the configuration of the scattered light detection optical system in the defect inspection apparatus according to the second embodiment of the present invention.

The basic configuration of the defect inspection apparatus of this embodiment is similar to that of the first embodiment.

In this embodiment, the upward scattered light of the wafer 1 is detected by the upward scattered light detection optical system 10, the front scattered light is detected by the front scattered light detection optical system 20, and the back scattered light is detected by the back scattered light detection optical system 30, respectively. Optical axes of the scattered light detection optical systems 10, 20 and 30 are present in the XZ plane, and a normal of the wafer 1 coincides with the optical axis of the upward scattered light detection optical system 10. Meanwhile, the front scattered light detection optical system 20 is inclined toward a +X direction, and the back scattered light detection optical system 30 is inclined toward a −X direction.

FIG. 8 shows the specific example thereof. Each of the scattered light detection optical systems 10, 20 and 30 has the same configuration. The constituent elements of the upward scattered light detection optical system 10 will be described as a representative.

The light scattered on the wafer 1 is captured by an objective lens 100. The captured light forms a dark field image by an imaging lens 115. A field stop 160 with a linear aperture is disposed at this position, and the illumination width and the aperture width are set so that a line-width direction of the linear illumination of the wafer 1 and an aperture of the field stop 160 becomes confocal.

The light that has penetrated through this field stop 160 forms a Fourier transform image by a Fourier transform lens 162. A spatial filter is disposed at this position to block the light diffracted from a periodic pattern. At this time, the patterns of various pitches are formed on the wafer 1, and accordingly the pitch of the spatial filter 170 can be controlled in this configuration.

Also, when there is no periodic pattern, the spatial filter 170 can be moved out of the optical path by a mechanism 172 for moving the spatial filter 170 out of the optical path.

Further, as a polarization filtering function for the detected light, a half-wave plate 175 and a polarizer 180 provided with a rotation mechanism 185 are disposed. Since this polarization filtering function is not used in some cases depending on the defect to be inspected, a movement mechanism 185 (same as the rotation mechanism) is provided for the half-wave plate 175 and the polarizer 180.

Furthermore, a dark field image after the space/polarization filtering is formed by the imaging lens 190, and the image sensor 200 is disposed at the imaging plane thereof.

Also, when the optical magnification is to be changed, the imaging lens 190 is switched to an imaging lens 192 with a different focal distance by an imaging lens switching mechanism 195 in this configuration. In the foregoing, the configuration has been described using the upward scattered light detection optical system 10, and the front scattered light detection optical system 20 and the back scattered light detection optical system 30 also have the same configuration.

In this embodiment, by detecting the back scattered light, the capture rate of the various types of defects can be improved.

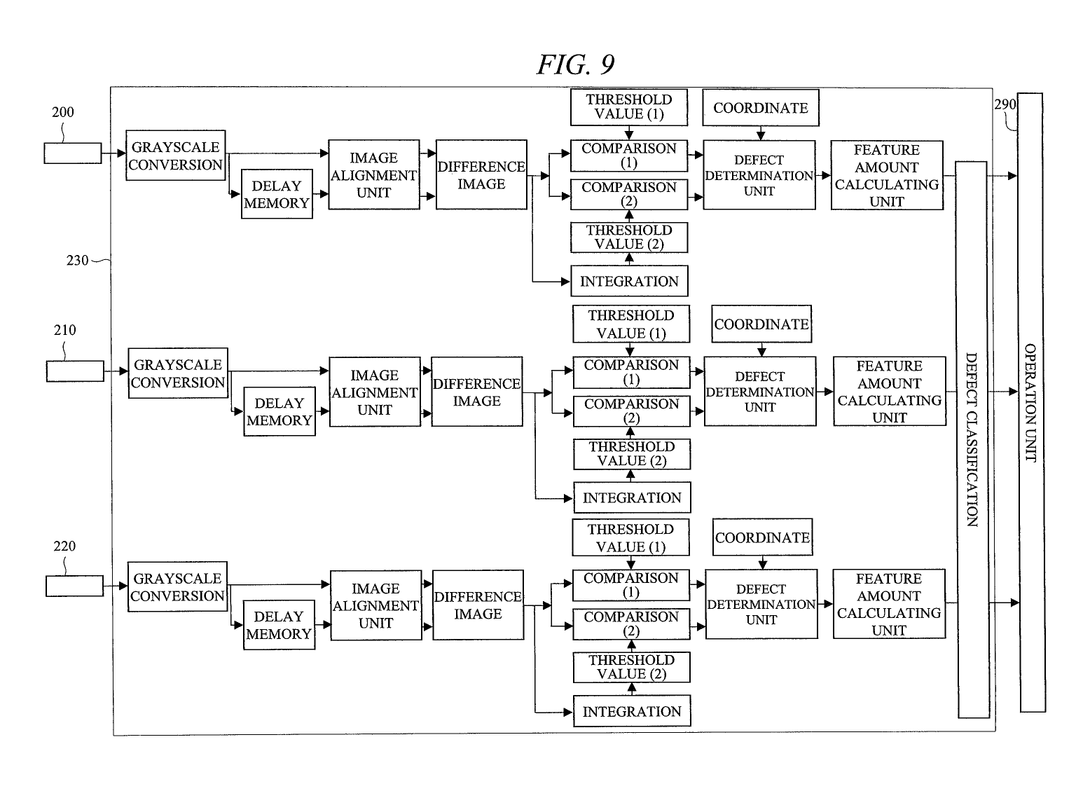

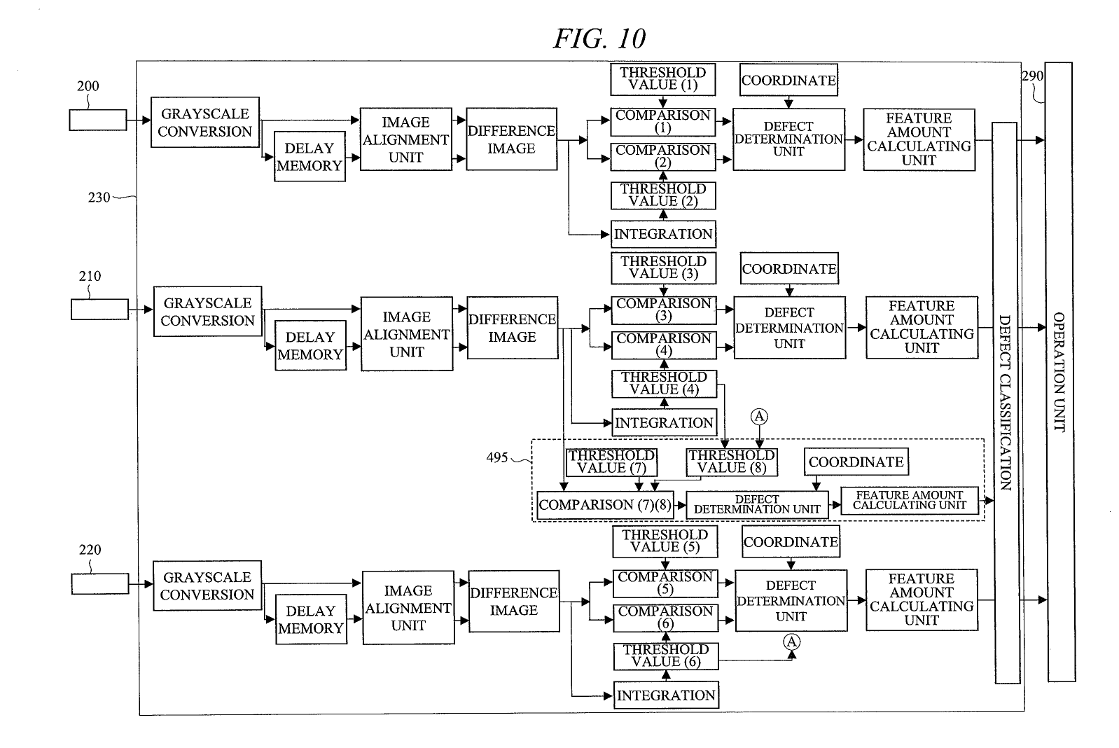

Next, the defect determination process in the image processing unit of the defect inspection apparatus according to the second embodiment of the present invention will be described with reference to FIG. 9 and FIG. 10. FIG. 9 and FIG. 10 are block diagrams for describing a defect determination process in the image processing unit of the defect inspection apparatus according to the second embodiment of the present invention.

FIG. 9 shows a flow of the defect determination process in which defects are detected based on the images obtained from the image sensors 200, 210 and 220 of the three detection systems shown in FIG. 7 and FIG. 8, and FIG. 10 shows a flow of the defect determination and classification process using the image feature amount in the middle of the image processing in addition to the determination in FIG. 9.

First, as shown in FIG. 9, the resolution of the luminance of the images detected by the image sensor 200, the image sensor 210 and the image sensor 220 is 1024 grayscales, and the grayscale conversion is performed when 1024 grayscales are converted into 256 grayscales at the time of the image processing. As the luminance conversion characteristics at the time of performing the grayscale conversion, a linear characteristic and a nonlinear characteristic can be selected.

The flow of processing the image detected by the image sensor 200 will be described below. The image whose luminance information is converted to 256 grayscales through the grayscale conversion is sent to both an image alignment unit and a delay memory. The image sent to the delay memory is sent to the alignment unit after the delay time equivalent to the pitch of the die in which the same pattern is formed in design. Therefore, two images such as the image detected in real time and the image of the adjacent die are sent to the alignment unit, and these two images are aligned.

Next, a difference image is calculated from the aligned images. The difference image is subjected to the threshold processes of two systems. The first threshold process is performed using a constant value for an absolute value of the difference image, and the image feature amount (luminance and size information) of the region higher than the threshold value is sent to the defect determination unit.

Also, with respect to the difference image sent to the second threshold processing unit, the variation in luminance is obtained from a plurality of difference images, and a threshold value based on the variation (dispersion threshold value) is generated and compared with the difference image. This threshold value is to be a floating threshold value. The image feature amount in the region higher than the floating threshold value is also sent to the defect determination unit similarly to the first threshold process.

The defect is comprehensively detected using the image feature amounts sent from the two systems. At this time, the unevenness in luminance is large in specific patterns and a normal portion is erroneously determined as a defect in some cases. Since the erroneous determination frequently occurs in a specific pattern, even if the region in which the erroneous determination frequently occurs is higher than the threshold value, the region is not determined as a defect by inputting coordinate information of a wafer to the defect determination unit, or a flag is set so as to indicate that there is high possibility of the erroneous determination. Thereafter, the image feature amounts are sent to the next feature amount calculating unit.

In this feature amount calculating unit, the feature amount is calculated using the detected images in more details than the image feature amount sent to a comparison unit.

The image processing is performed for the image sensors 210 and 220 in the same manner, and the image feature amount of the defect portion is calculated.

Based on the calculated image feature amounts of the image sensors 200, 210 and 220 mentioned above, the defects are classified. The classification results, coordinate information and the feature amount of the image are output to the operation unit 290. An operator can visually check the output information, and the information is sent to a high-order system for managing the LSI manufacturing process.

Further, as shown in FIG. 10, the basic process flow of the process of determining and classifying the defects by using an image feature amount in the middle of the image processing is similar to that of FIG. 9, and the difference therebetween lies in an anisotropic scattered image comparison unit 495 using images of two or more systems.

Although the comparison of an image obtained by the sensor 210 for detecting the front scattered light and an image obtained by the image sensor 220 for detecting the back scattered light is shown in FIG. 10, the comparison of three images by using the image sensor 200 for detecting the upper scattered light or the comparison of the images of two systems of the image sensors 200 and 210 is also possible.

Difference images of the images detected by the image sensor 210 and the image sensor 220 are calculated from the respective adjacent dies, and the difference images of the two systems are sent to the anisotropic scattered image comparison unit 495. The difference images of these two systems are compared, and are compared with a fixed threshold value (possible if a code is attached) and a dispersion threshold value.

Then, coordinate information on a wafer (coordinates in a die and coordinates in the whole wafer) is input, and the region exceeding the defect determination reference is determined as a defect. Next, the feature amount of the defect (for example, luminance ratio of the front scattered light image and the back scattered light image) is obtained from the information and is defined as the feature amount data for the defect classification.

### Third Embodiment

In the third embodiment, the front scattered light, the wafer upward scattered light (mainly side scattered light) and the back scattered light are detected by a high NA objective lens.

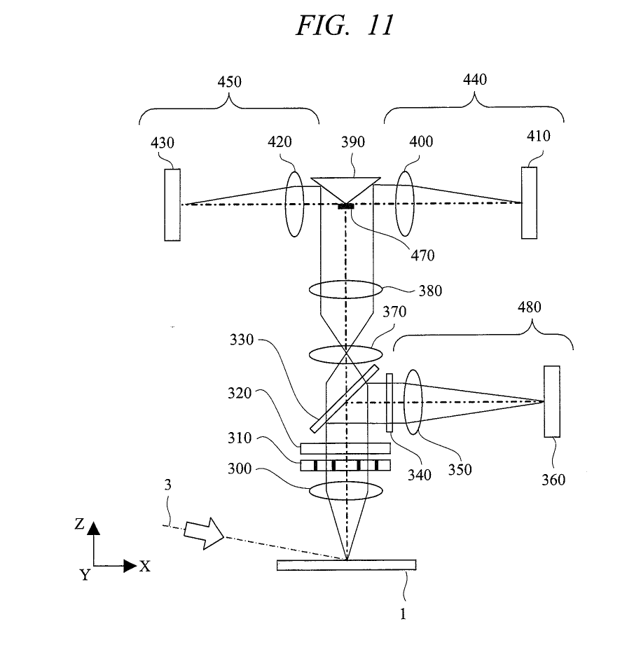

The configuration of a defect inspection apparatus according to the third embodiment of the present invention will be described with reference to FIG. 11. FIG. 11 is a configuration diagram showing the configuration of the scattered light detection optical system in the defect inspection apparatus according to the third embodiment of the present invention.

In FIG. 11, the illumination light is inclined at 10 to 45 degrees with respect to the Y direction, and an objective lens 300 with the NA of 0.7 or more (NA0.75 to NA0.95) is disposed above. The captured scattered light forms a Fourier transform image by a Fourier transform lens formed in the objective lens 300. The spatial filter 310 that can set the arbitrary light blocking pitch is disposed at this position. Next, a rotatable half-wave plate 320 is disposed so that elements of the scattered light reflected by or transmitted through a polarization beam splitter 330 which is first branching means disposed on an image side can be selected.

The scattered light with the S polarization element which has been reflected is directed to an upward detection optical path 480 and a dark field image is formed on the surface of an image sensor 360 by an imaging lens 350. The P polarization element which has penetrated through the polarization beam splitter 330 forms a Fourier transform image again by lens 370 and 380.

A dividing mirror 390 which is second branching means whose apex of a mirror surface has a knife-edge shape is disposed at this position, thereby branching the optical path into two paths in the X direction. At this time, by disposing the apex of the dividing mirror 390 so as to almost coincide with the optical path of the objective lens 300, the pupil plane can be equally divided into two parts and optical images can be formed.

However, it is not always necessary to dispose the dividing mirror 390 so as to equally divide the pupil plane, and the dividing mirror 390 can be disposed so that the back scattered side with a small amount of scattered light has a larger reflection area. Further, when the stray light due to the scattering at the knife-edge portion of the dividing mirror 390 and a spatial frequency element are to be blocked, a spatial filter 470 is disposed at this position.

Of the two optical paths formed by the dividing lens 390, the front scattered light detection optical path 440 detecting the front scattered light is provided with an imaging lens 400, thereby forming a dark field image on an image sensor 410.

Also, the other back scattered light detection optical path reflected by the dividing mirror 390 is provided with an imaging lens 420, thereby forming a dark field image on an image sensor 430.

Note that, since the upward detection optical path 480 and the front and back scattered light detection paths 440 and 450 differ in a numerical aperture, the amount of detected light also differs. Therefore, an ND filter 340 for adjusting the light amount is disposed on the upward detection optical path 480 with a large amount of detected light.

As the ND filter 340, an ND light filter having plural transmissivities is prepared, and the appropriate transmissivity can be selected in accordance with a wafer and a defect to be inspected (not shown).

Also, although the case where the dividing direction of the dividing mirror 390 is the X direction has been described in FIG. 11, the direction may be the Y direction, and the direction may be the angle of 45 degrees at the middle of the X direction and the Y direction and any other angles in an extreme case.

Further, the defect determination process in the image processing unit in this embodiment is similar to that in the second embodiment, and the image sensors in FIG. 7 and FIG. 8 of the second embodiment and the image sensors in FIG. 11 of this embodiment have the relation that the image sensor 200 corresponds to the image sensor 360, the image sensor 210 corresponds to the image sensor 410, and the sensor image 220 corresponds to the image sensor 430.

As described above, in this embodiment, a defect can be detected only by one high NA objective lens.

In the foregoing, the invention made by the inventors of the present invention has been concretely described based on the embodiments. However, it is needless to say that the present invention is not limited to the foregoing embodiments and various modifications and alterations can be made within the scope of the present invention.

For example, various combinations can be considered for the configurations, functions and contents of the image processing described in the first to third embodiments, but these combinations are also within the scope of the present invention.

The embodiments of the present invention described above can be widely applied to a defect inspection apparatus and a defect inspection system for defects and foreign matters of the fine patterns which are formed on a substrate through the thin-film process as typified by the semiconductor manufacturing process and the manufacturing process of a flat panel display.

Also, the effects obtained by typical aspects of the present invention will be briefly described below.

More specifically, according to the present invention, in accordance with the scattered light distribution from a defect to be inspected on a wafer, the region with a strong scattered light distribution can be matched with the scattered light capturing region of the detection optical unit, and the defect detection sensitivity can be improved. Also, the illumination light is disposed in an orientation where the specular reflection light from a normal pattern is not detected, thereby suppressing the noise on the defect detection and improving the inspection S/N ratio.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A defect inspection method for detecting a defect of a sample on which circuit patterns are formed,
wherein the sample is scanned in a horizontal plane by a scanning unit,
light is illuminated to the sample at an oblique angle with respect to a normal of a surface of the sample by an illumination optical unit,
the illumination light is illuminated in a linear form on the sample at an angle inclined with respect to a direction perpendicular to the scanning direction,
scattered light from the region illuminated in the linear form is detected by a detection optical unit,
the detection optical unit is disposed in the same orientation as the scanning direction and has an aperture which does not spatially detect a specular reflection light from a pattern parallel to the scanning direction,
an image formed by the detection optical unit is detected by an image sensor, and
the image detected by the image sensor is subjected to a comparison operation by an image processing unit, thereby determining a defect candidate.

2. The defect inspection method according to claim 1,
wherein the illumination light of the illumination optical unit is illuminated from a position shifted by 10 degrees to 45 degrees with respect to the direction perpendicular to the scanning direction.

3. The defect inspection method according to claim 1,
wherein the scattered light is detected by a plurality of detection optical units disposed in a direction perpendicular to a plane including the normal of the sample and a longitudinal direction of the illumination in the linear form,
images formed by the plurality of detection optical units are detected by a plurality of image sensors, and
the images detected by the plurality of image sensors are subjected to a comparison operation by the image processing unit, thereby determining a defect candidate.

4. The defect inspection method according to claim 3,
wherein images having different scattering directions detected by the plurality of image sensors are compared by the image processing unit, thereby obtaining a feature amount of a defect, and
the defect candidate is determined based on the feature amount of the defect.

5. A defect inspection apparatus for detecting a defect of a sample on which circuit patterns are formed, the apparatus comprising:
a scanning unit which scans the sample in a horizontal plane;
an illumination optical unit which illuminates light to the sample at an oblique angle with respect to a normal of a surface of the sample, and illuminates light in a linear form on the sample at an angle inclined with respect to a direction perpendicular to the scanning direction of the scanning unit;
a detection optical unit which is disposed in the same orientation as the scanning direction, positioned at an elevation angle where a specular reflection light from a pattern parallel to the scanning direction is not spatially detected, and detects scattered light from a region illuminated in the linear form;
an image sensor which detects an image formed by the detection optical unit; and
an image processing unit which performs a comparison operation of the image detected by the image sensor, thereby determining a defect candidate.

6. The defect inspection apparatus according to claim 5,
wherein the illumination light of the illumination optical unit is illuminated from a position shifted by 10 degrees to 45 degrees with respect to the direction perpendicular to the scanning direction.

7. The defect inspection apparatus according to claim 5, further comprising:
a plurality of detection optical units disposed in a direction perpendicular to a plane including the normal of the sample and a longitudinal direction of the illumination in the linear form; and
a plurality of image sensors which detect images formed by the plurality of detection optical units,
wherein the image processing unit performs a comparison operation of the images detected by the plurality of image sensors, thereby determining a defect candidate.

8. A defect inspection apparatus for detecting a defect of a sample on which circuit patterns are formed, the apparatus comprising:
a scanning unit which scans the sample in a horizontal plane;
an illumination optical unit which illuminates light to the sample at an oblique angle with respect to a normal of a surface of the sample, and illuminates light in a linear form on the sample at an angle inclined with respect to a direction perpendicular to the scanning direction of the scanning unit;
a detection optical unit with NA of 0.7 or more which detects scattered light from a region illuminated in the linear form;
first branching means which branches the scattered light detected by the detection optical unit into at least two or more optical paths by polarization separation;
second branching means which further branches at least one of the optical paths branched by the first branching means into two or more optical paths by a Fourier transform plane;
a plurality of image sensors which detect images formed by each of the optical paths branched by the first branching means and the second branching means; and
an image processing unit which performs a comparison operation of the images detected by the plurality of image sensors, thereby determining a defect candidate.

9. The defect inspection apparatus according to claim 8,
wherein the image processing unit compares images having different scattering directions detected by the plurality of image sensors, thereby obtaining a feature amount of a defect, and determines a defect candidate based on the feature amount of the defect.
